(19) United States
(12) Patent Application Publication
(10) Pub. No.: US 2010/0236022 A1
(43) Pub. Date: Sep. 23, 2010

(54) MECHANISM FOR CHANGING RELATIVE POSITIONS AND ATTITUDES OF TWO OBJECT CONNECTED TO EACH OTHER

(75) Inventor: Chang Seop Lee, Bangbae-dong (KR)

Correspondence Address: EDWARDS ANGELL PALMER & DODGE LLP, P.O. BOX 55874, BOSTON, MA, 02205, US

(73) Assignee: QLT CO., LTD., Seoul (KR)

(21) Appl. No.: 12/760,392

(22) Filed: Apr. 14, 2010

Related U.S. Application Data
(62) Division of application No. 11/996,579, filed on Jan. 23, 2008, now abandoned.

(30) Foreign Application Priority Data
Jul. 29, 2005 (KR) 10-2005-0069268

(51) Int. Cl. F16C 11/00; E05D 7/00

(52) U.S. Cl. 16/308; 16/357

(57) ABSTRACT

The present invention provides a simple connecting mechanism disposed between a stationary body and a movable body to simply change relative positions and attitudes of the movable body with respect to the stationary body, and it is possible to simply manufacture a sunvisor, an armrest, a portable table by using the mechanism.

### TECHNICAL FIELD

The present invention relates to a mechanism for changing relative positions and attitudes of tow object connected to each other and, more particularly, to a mechanism for connection between one fixed object (hereinafter, referred to as “stationary body”) and an object (hereinafter, referred to as “movable body”) whose position and attitude relatively changes with respect to the stationary body.

### BACKGROUND ART

Generally, a sunvisor for a vehicle is configured to have three positions-‘accommodated position’ in which the sunvisor is accommodated parallel to a roof of a vehicle, ‘front side blocking position’ in which the sunvisor blocks light entering the front side of the vehicle, and ‘lateral side blocking position’ in which the sunvisor blocks light entering the lateral side of the vehicle. In order to allow the sunvisor to have various positions with respect to a vehicle body, a mechanism for connecting a stationary body that is fixed to the vehicle body and a movable body (here, a light-shielding panel of the sunvisor) that changes appropriate positions and attitudes with respect to the stationary body.

An armrest of a vehicle is preferably movable between a projected position in which the armrest projects from a seat so as to support an occupant's arm and a depression position in which the armrest is rotated towards a seat so as to make the best use of the space. In order to allow the armrest to move between the positions, a mechanism which connects a stationary body which fixes the armrest to a seat or a structure around the seat and a movable body (armrest) which changes positions and attitudes with respect to the stationary body is required.

### DISCLOSURE OF INVENTION

### Technical Problem

It is an object of the present invention to provide a connecting mechanism between a stationary body and a movable body which can be used in a device for changing relative positions and attitudes of the movable body with respect to the optional stationary body, such as an armrest and sunvisor, and has a simple structure.

### Technical Solution

In order to achieve the above-described object, according to an aspect of the present invention, a mechanism for changing relative positions and attitudes of two objects connected to each other includes: a stationary body having a linear guide; a movable body having a guide; a slider that is disposed to linearly slide on the linear guide and has a pivot protrusion rotatably inserted in the movable body; and a guide pin that is disposed to protrude from the stationary body so as to be guided by the guide.

Further, according to another aspect of the present invention, the mechanism includes: a stationary body; a movable body having a guide; a rotation arm that is rotatably disposed in the stationary body and has a pivot protrusion rotatably inserted in the movable body; and a guide pin that is disposed to protrude from the stationary body so as to be guided by the guide.

### ADVANTAGEOUS EFFECTS

According to the aspects of the present invention, provided is a simple connecting mechanism disposed between a stationary body and a movable body to simply change relative positions and attitudes of the movable body with respect to the stationary body, and it is possible to simply manufacture a sunvisor, an armrest, a portable table by using the mechanism.

### BRIEF DESCRIPTION OF THE DRAWINGS

FIG. 1 is a view showing a mechanism for changing relative positions and attitudes of two objects connected to each other according to a first embodiment of the present invention.

FIG. 2 is a view showing an initial position of FIG. 1 in detail.

FIG. 3 is a view showing a final position of FIG. 1 in detail.

FIGS. 4 to 8 are views illustrating the mechanism according to the first embodiment.

FIG. 9 is a view showing a mechanism for changing relative positions and attitudes of two objects connected to each other according to a second embodiment of the present invention.

FIG. 10 is a view showing an initial position of FIG. 9 in detail.

FIG. 11 is a view showing a final position of FIG. 9 in detail.

FIGS. 12 to 16 are views illustrating the mechanism according to the second embodiment.

### MODE FOR THE INVENTION

Hereinafter, preferred embodiments of the present invention will be described with reference to the accompanying drawings.

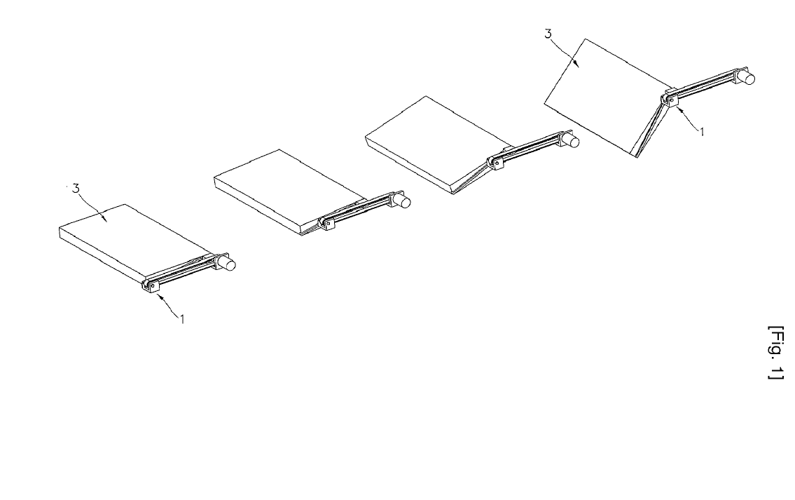

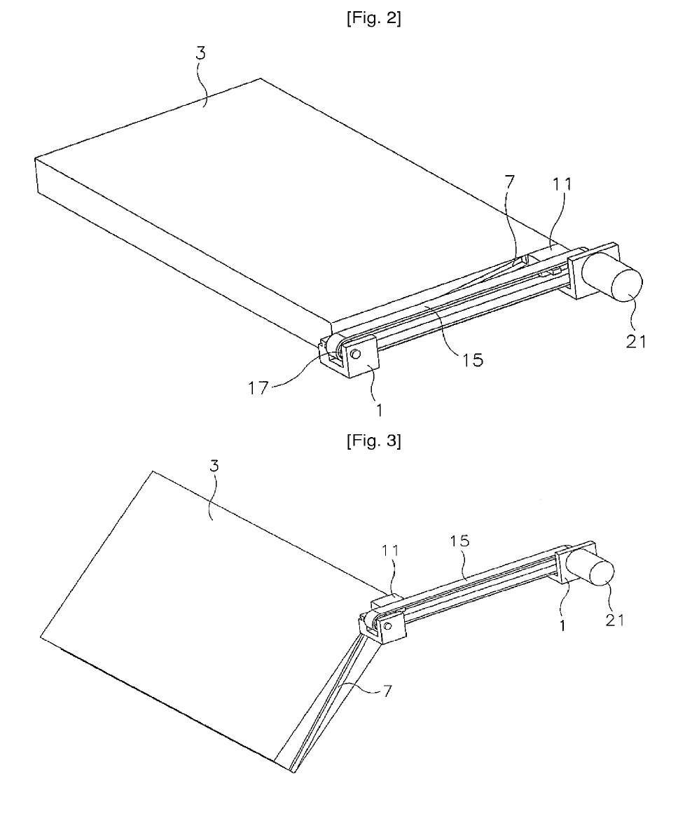

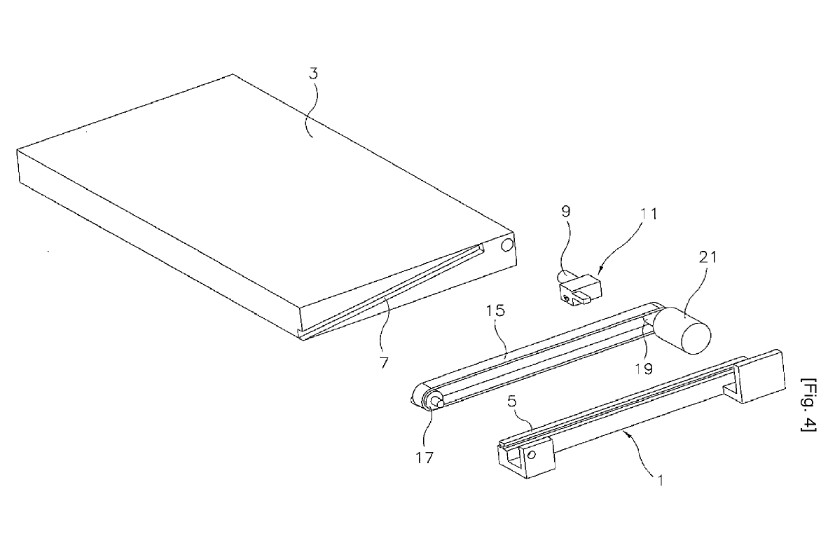

FIG. 1 is a view showing a first embodiment of the present invention, sequentially illustrating changes of positions and attitudes of a movable body 3 with respect to a stationary body 1 from an initial position of the leftmost side to a final position of the rightmost side. FIGS. 2 and 3 illustrate the initial and final positions in detail.

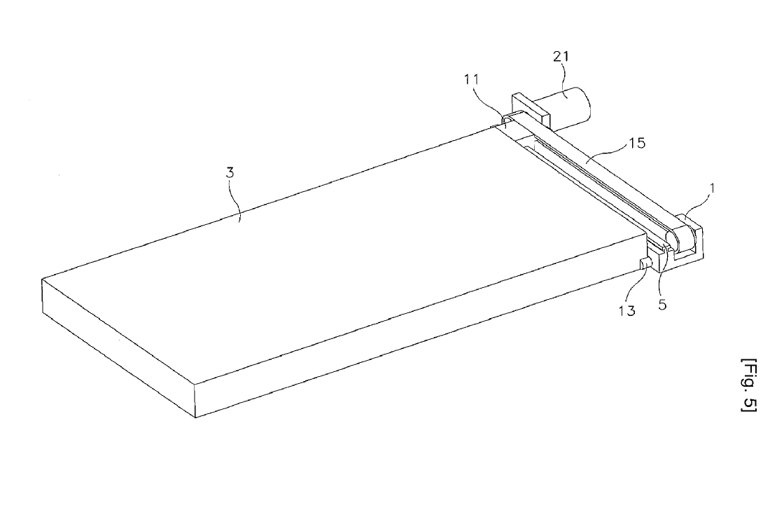

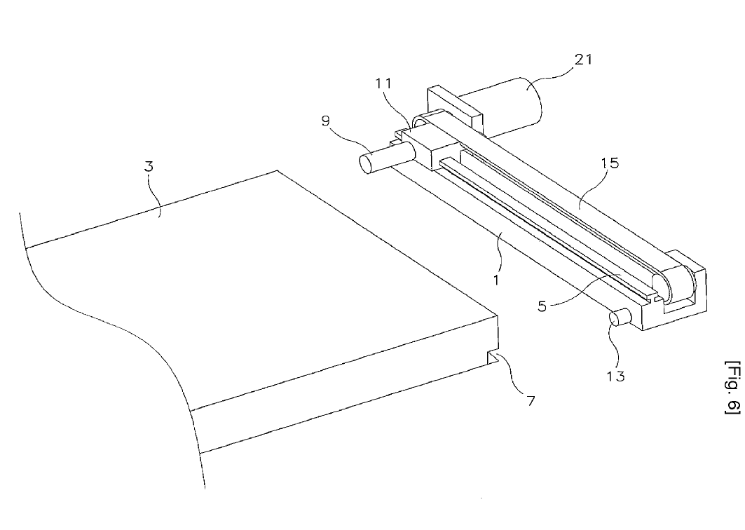

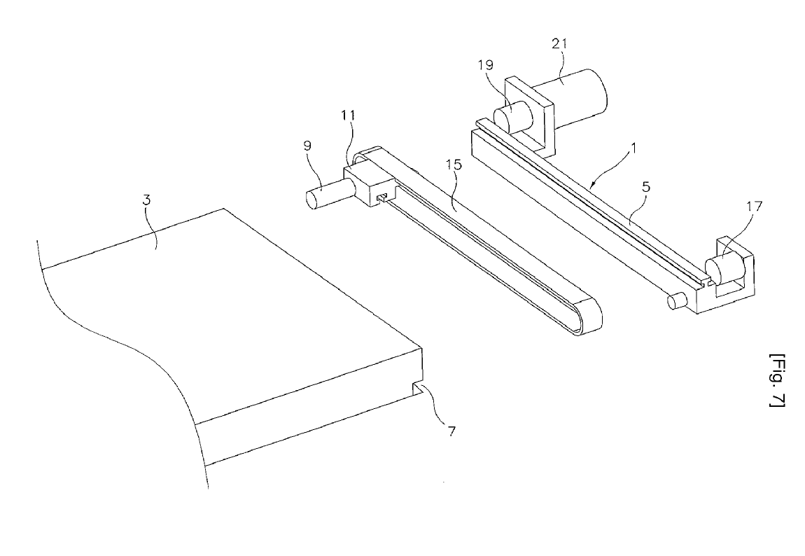

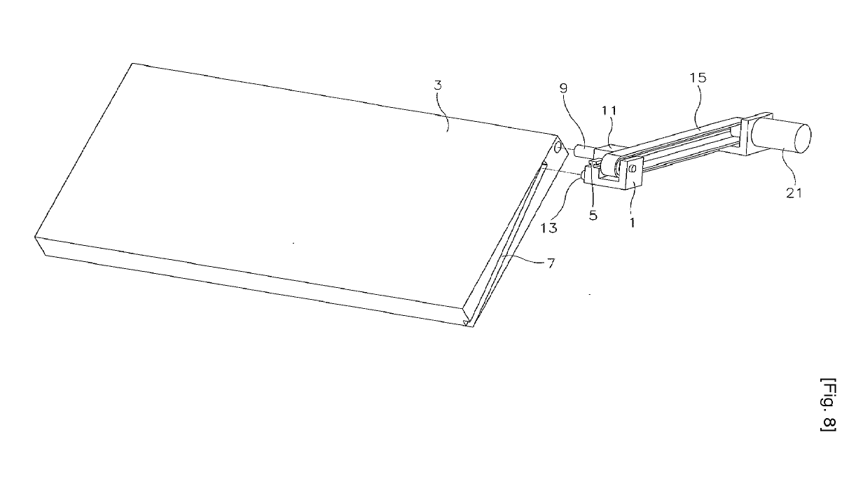

FIGS. 4 to 8 specifically illustrate a connecting mechanism provided between the stationary body 1 and the movable body 3 in order to embody the movement shown in FIG. 1. With reference to the drawings, the mechanism of the present invention includes the stationary body 1 having a linear guide 5, the movable body 3 having a guide 7, a slider 11 disposed to linearly slide on the linear guide 5 and having a pivot protrusion 9 rotatably inserted in the movable body 3, a guide pin 13 disposed to protrude from the stationary body 1 to be guided by the guide 7.

The pivot protrusion 9 of the slider 11 is positioned above the guide pin 13, and the guide 7 is in the form of a linear groove which inclines toward the guide pin 13 from the pivot protrusion 9 with respect to the linear guide 5 in the initial position.

Although the guide 7 is in the form of a linear groove in the present embodiment, it can be modified into various shape, such as a circular arc, having an arbitrary planar locus on the plane of the movable body vertically facing the guide pin 13, so that changes of positions and attitudes of the movable body with respect to the stationary body can be embodied somewhat differently.

Further, in the present embodiment, the mechanism further includes a linear movement means which allows the slider 11 to linearly slide along the linear guide 5, so that the relative positions and attitudes of the movable body 3 with respect to the stationary body 1 automatically change.

In the present embodiment, the linear movement means includes a belt 15 to which the slider 11 is connected, an idler pulley 17 disposed in the stationary body 1 to support the belt 15, a drive pulley 19 disposed in the stationary body 1 to drive the belt 15, and a motor 21.

Besides, a rack is formed in the stationary body 1, and the mechanism includes a pinion which is geared with the rack and rotatably disposed in the slider 11. Rotation of the pinion enables the slider 11 to move linearly.

In the initial position of the leftmost of FIG. 1, as the motor 21 rotates to drive the belt 15, the slider 11 fixed to the belt 15 linearly moves to the left (in the drawing) along the guide 5.

Since the pivot protrusion 9 of the slider 11 is rotatably inserted in the movable body 3, the movable body 3 linearly moves along the slider 11, following the movement of the slider 11.

The guide pin 13 fixed to the stationary body 1 is inserted in the guide 7 of the movable body 3, and the guide 7 is inclined with respect to the guide 5. Therefore, if the movable body 3 linearly moves towards the guide pin 13 together with the slider 13, the movable body 3 rotates around the pivot protrusion 9 as a rotation axis as the pivot protrusion 9 gets closer to the guide pin 13.

In other words, the movable body 3 linearly moves and rotates, as it linearly moves together with the slider 11 and thus gets closer to the guide pin 13.

The movable body 3 linearly moves and rotates with respect to the stationary body 1 according to the drive of the belt 15, and it finally moves to the rightmost position, reaching to the final position in which relative positions and attitudes with respect to the stationary body 1 have completely changed.

On the other hand, if the motor is reversely rotated, the relative positions and attitudes of the movable body 3 with respect to the stationary body 1 change from the final position to the initial position. Finally, the movable body 3 can automatically switch between the initial position and the final position with respect to the stationary body 1.

As described above, the mechanism for changing relative positions and attitudes of the movable body 3 with respect to the stationary body 1 can be applied to a sunvisor, armrest, portable table, etc.

In other words, when the stationary body 1 corresponds to a part to be fixed to a vehicle body and the movable body 3 corresponds to a light-shielding panel of the sunvisor, the light-shielding panel is accommodated substantially parallel to a roof panel of a vehicle in the initial position of FIG. 1, and the light-shielding panel protrudes towards an occupant in the final position so as to block light entering the front side of a vehicle.

Naturally, as the belt 15 is driven by operating the motor 21, the movable body 3 can automatically switch between the accommodated position and the front side blocking position with respect to the stationary body 1. Further, if the linear movement means is not provided, an occupant can manually push or pull the movable body 3 along the linear guide 5 so as to switch between the two positions.

Likewise, if the stationary body 1 is fixed to a seat or a structure around the seat and the movable body 3 corresponds to an armrest, the initial position of FIG. 1 corresponds to a position in which the armrest stands substantially vertical to a seat back of the seat, and the final position of FIG. 1 corresponds to a position in which the armrest protrudes from the seat so as to support an occupant's arm.

Of course, as well in the armrest device configured as described above, the linear movement means allows switch between the initial position and the final position. If a separate linear movement means is not provided, an occupant can manually switch between the two positions.

As another example of the above-described mechanism, a portable table disposed at the rear side of a seat back of a vehicle can be taken. In this case, a panel forming the table corresponds to the movable body 3 and the stationary body 1 is fixed to the seat back, and the panel is accommodated substantially parallel to a seat back in the initial position, and as the position is changed to the final position, the panel is unfolded horizontally for the convenience of an occupant at the rear side of the seat back.

In the mechanism of the first embodiment, the relative positions and attitudes change as the movable body 3 linearly moves and rotates with respect to the stationary body 1. Meanwhile, in a second embodiment, a mechanism is disclosed in which the relative positions and attitudes change as the movable body 3 rotates around two separate rotation axes with respect to the stationary body 1.

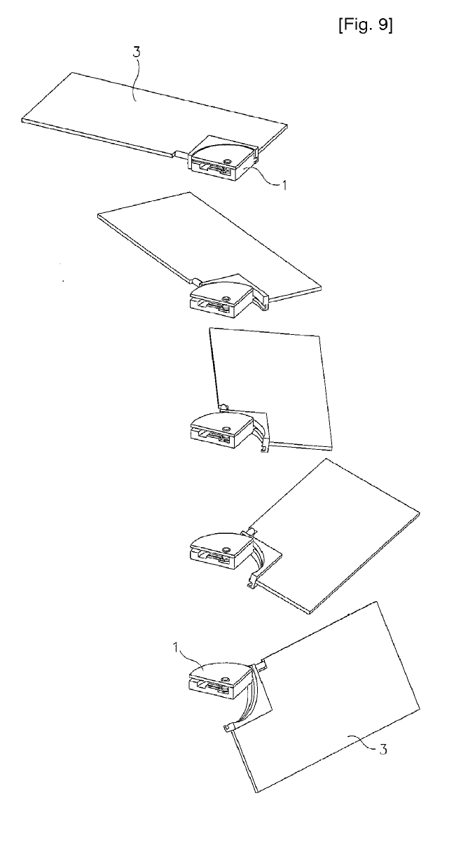

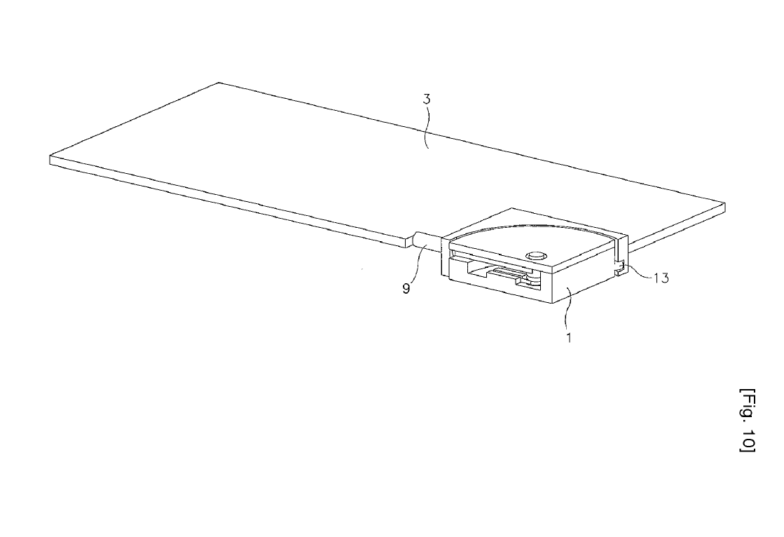

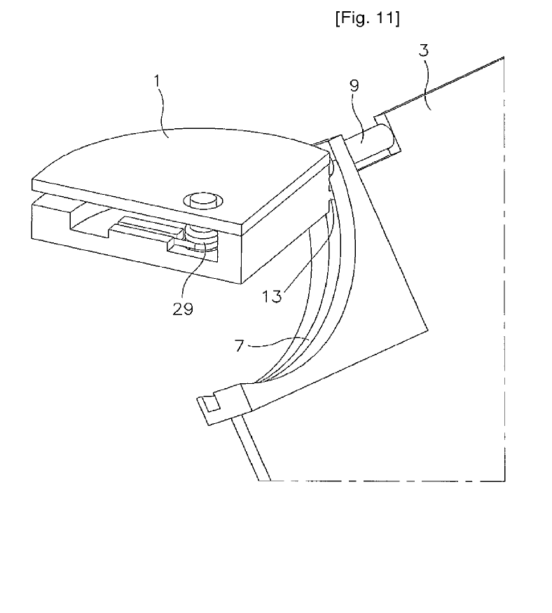

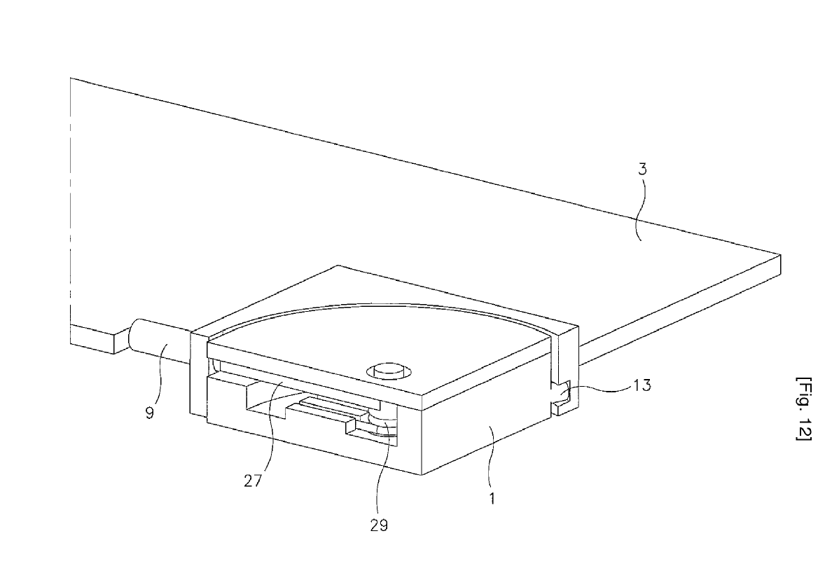

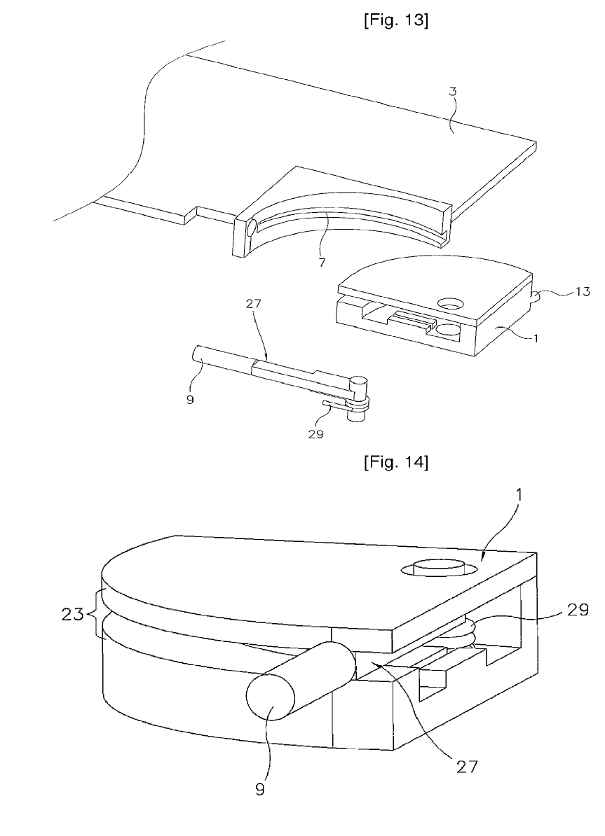

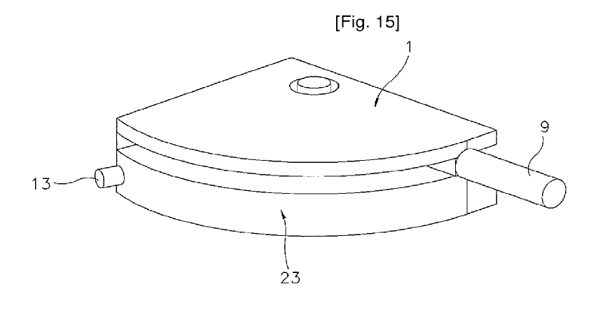

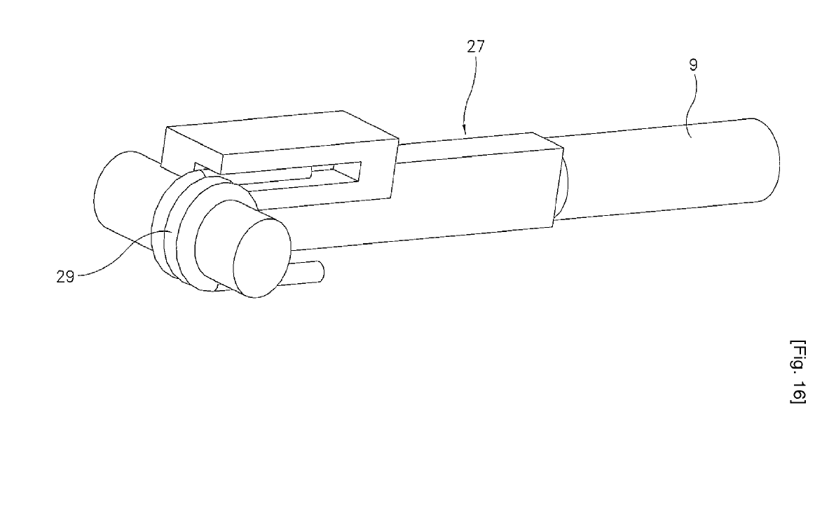

FIG. 9 is a view showing the second embodiment of the present invention, sequentially illustrating changes of positions and attitudes from an initial position of the uppermost side to a final position of the lowermost side. FIGS. 10 and 11 illustrate the initial and final positions in detail. FIGS. 12 to 16 specifically illustrate the mechanism according to the present embodiment. With reference to the drawings, the mechanism includes the stationary body 1, the movable body 3 having the guide 7, a rotation arm 27 which is rotatably disposed in the stationary body 1 and has the pivot protrusion 9 rotatably inserted in the movable body 3, and the guide pin 13 disposed to protrude from the stationary body 1 so as to be guided by the guide 7.

The pivot protrusion 9 of the rotation arm 27 is positioned above the guide pin 13, and the guide 7 is in the form of a spiral groove which is constantly inclined towards the guide pin 13 from the pivot protrusion 9 with respect to a rotation plane of the rotation arm 27 in the initial position.

In other words, the guide 7 is formed in a spiral shape that is concentric with the rotation axis of the rotation arm 27 and gradually inclined towards the guide pin 13 from the pivot protrusion 9.

It is not necessary to form the guide 7 to be constantly inclined towards the guide pin 13 from the pivot protrusion 9 with respect to the rotation plane of the rotation arm 27. That is, the inclination of the guide 7 can be modified to change the relative positions and attitudes of the stationary body 1 with respect to the movable body 3.

Meanwhile, in the present embodiment, the stationary body 1 includes a circular arc guide 23. The circular arc guide 23 is formed along an arc having a constant radius from the rotation axis of the rotation arm 27 so as to form an arc surface facing the surface of the guide 7 of the movable body 3. Therefore, the circular arc guide 23 can guide the rotation arm 27 and the movable body 3 to more stably rotate with respect to the stationary body 1.

Further, in the present embodiment, the mechanism further includes a rotating means which rotates the rotation arm 27 along the circular arc guide 23, and the rotating means is a torsion spring 29 disposed between the rotation arm 27 and the stationary body 1.

One end of the torsion spring 29 is inserted in the rotation arm 27 as shown in FIG. 16, and the other end is inserted in the stationary body 1, so that the torsion spring 29 applies an elastic force in a direction to move the rotation arm 27 to the final position.

Therefore, it can be only seen the changes of positions from an initial position a final position of the lowermost side of the movable body 3 in FIG. 9. However, in order to sustain the initial position, it is preferable to configure the mechanism to prevent the movable body 3 from moving due to an elastic force of the torsion spring by using a fixing clip connected to the stationary body 1 to fix the movable body 3 thereto.

Of course, with the rotation means, the rotation arm 27 can be rotated with respect to the stationary body 1 by using a separate motor other than the torsion spring 29. In this case, the above-mentioned fixing clip is unnecessary.

If the movable body 3 is released by releasing the fixing clip in the initial position of the uppermost side of FIG. 9, the rotation arm 27 rotates along the circular arc guide 23 by an elastic force of the torsion spring 29.

Since the rotation arm 27 includes the pivot protrusion 9 that is rotatably inserted in the movable body 3, the movable body 3 rotates along the circular arc guide 23 in accordance with the rotation of the rotation arm 27.

The guide pin 13 which protrudes from the stationary body 1 is inserted in the guide 7 of the movable body 3, and the guide 7 is inclined towards the circular arc guide 23. Therefore, as the rotation arm 27 rotates and approaches towards the guide pin 13, the movable body 3 gradually rotates around the pivot protrusion 9 as the rotation axis.

In other words, while revolving around the rotation axis of the rotation arm 27 together with the rotation arm 27, the movable body 3 rotates around the pivot protrusion 9 as the rotation axis.

As described above, the movable body 3 revolves and rotates by an elastic force of the torsion spring 29 applied between the rotation arm 27 and the stationary body 1 and thus moves to the final position of the lowermost side of FIG. 9. In other words, the relative positions and attitudes of the movable body 3 with respect to the stationary body 1 completely change to the final position.

On the other hand, if an occupant resists against the force of the torsion spring 29 and reversely rotates the rotation arm 27, the movable body 3 reversely revolves and rotates and then returns to the initial position, and the initial position can be sustained by using a fixing clip.

As described above, the mechanism for changing the relative positions and attitudes of the movable body 3 with respect to the stationary body 1 can be applied to a sunvisor.

That is, if the stationary body 1 corresponds to a stationary part to be fixed to a roof panel of a vehicle, and the movable body 3 corresponds to a light-shielding panel of the sunvisor, the initial position of FIG. 9 corresponds to a position, seen from the front side of the vehicle, in which the light-shielding panel is accommodated substantially parallel to the roof panel of the vehicle.

Of course, the movable body 3 is sustained to be fixed to the vehicle body in the initial position by a separate fixing clip. Further, if an occupant has the fixing clip released, the movable body 3 revolves and rotates along with the rotation arm 27 by an elastic force of the torsion spring 29 and then automatically reaches to the final position.

If an occupant pushes the movable body 3 while resisting against an elastic force that the torsion spring 29 provides after using, the movable body 3 reversely revolves and rotates along with the rotation arm 27 and then returns to the initial position, and the initial position, that is, the accommodated position, can be sustained by fixing the movable body 3 to the fixing clip.

On the other hand, when a separate motor is used without using the torsion spring 29 as the rotation means, it is possible to provide a more sophisticated product, by automatically changing the initial position and the final position of the light-shielding panel, that is, the movable body 3 with respect to the stationary body 1 according to whether power is supplied to a motor or not and switch of the supply direction.

1-12. (canceled)

13. A mechanism for changing relative positions and attitudes of two objects connected to each other, comprising:
a stationary body;
a movable body having a guide;
a rotation arm that is rotatably disposed in the stationary body and has a pivot protrusion rotatably inserted in the movable body; and
a guide pin that is disposed to protrude from the stationary body so as to be guided by the guide.

14. The mechanism of claim 13,
wherein the pivot protrusion of the rotation arm is positioned above the guide pin, and
the guide is in the form of a spiral groove that is constantly inclined towards the guide pin from the pivot protrusion with respect to the rotation plane of the rotation arm in an initial position.

15. The mechanism of claim 13, further comprising:
a rotating movement means which allows the rotation arm to rotate with respect to the stationary body.

16. The mechanism of claim 15,
wherein the rotating movement means is a torsion spring disposed between the rotation arm and the stationary body.

17-20. (canceled)
